(19) United States
(12) Patent Application Publication
(10) Pub. No.: US 2024/0317140 A1
(43) Pub. Date: Sep. 26, 2024

(54) FEATURE FOR REARVIEW ASSEMBLY HOLDING ADDITIONAL HMI

(71) Applicant: Gentex Corporation, Zeeland, MI (US)

(72) Inventors: Ingo R. Schwetz, Flein (DE); Horia-Eduard Pilat, Pulheim (DE)

(73) Assignee: Gentex Corporation, Zeeland, MI (US)

(21) Appl. No.: 18/610,598

(22) Filed: Mar. 20, 2024

Related U.S. Application Data
(60) Provisional application No. 63/453,535, filed on Mar. 21, 2023.

(51) Int. Cl. B60R 1/12; B60R 1/04

(52) U.S. Cl. CPC B60R 1/12; B60R 1/04

(57) ABSTRACT

A mirror assembly for a vehicle that includes a mirror housing and a mounting member configured to attach the mirror housing to the vehicle. An optical stack includes an electro-optic assembly that is located in the mirror housing. The electro-optic assembly includes a substantially transmissive front substrate. The front substrate defines a first surface and a second surface. The electro-optic assembly further includes a rear substrate that defines a third surface and a fourth surface. An electro-optic medium is disposed between the front substrate and the rear substrate. A mirror display is located in the mirror housing. A user interface module is connected to at least one of the mounting member and an exterior of the mirror housing.

### CROSS-REFERENCE TO RELATED APPLICATION

This application claims priority to and the benefit under 35 U.S.C. § 119(e) of U.S. Provisional Application No. 63/453,535, filed on Mar. 21, 2023, entitled “FEATURE FOR REARVIEW ASSEMBLY HOLDING ADDITIONAL HMI,” the disclosure of which is hereby incorporated herein by reference in its entirety.

### FIELD OF THE DISCLOSURE

The present disclosure generally relates to a user interface module, and, more particularly, to a user interface module that is coupled to a rearview mirror assembly.

### SUMMARY OF THE DISCLOSURE

According to one aspect of the present disclosure, a mirror assembly for a vehicle includes a mirror housing and a mounting member configured to attach the mirror housing to the vehicle. An optical stack includes an electro-optic assembly that is located in the mirror housing. The electro-optic assembly includes a substantially transmissive front substrate, the front substrate defines a first surface and a second surface. The electro-optic assembly further includes a rear substrate that defines a third surface and a fourth surface. An electro-optic medium is disposed between the front substrate and the rear substrate. A mirror display is located in the mirror housing. A user interface module is connected to at least one of the mounting member and an exterior of the mirror housing.

According to another aspect of the present disclosure, a mirror assembly for a vehicle includes a mirror housing defining at least one opening. A mirror viewing surface is coupled to the mirror housing and a mounting member is configured to attach the mirror housing to the vehicle. At least one user interface module is coupled to the mirror housing and moveable between a stowed position within the at least one opening and an active position at least partially outside of the at least one opening. The at least one user interface module includes at least one user input configured to be in communication with at least one of a mirror control system or a vehicle control system. The at least one user interface module further includes a module viewing surface configured to visualize a blind spot by at least one of generating images of the blind spot on a display or reflecting the blind spot from a reflective surface.

According to yet another aspect of the present disclosure, a mirror assembly for a vehicle includes a mirror housing and a mirror viewing surface coupled to the mirror housing. A mounting member is configured to attach the mirror housing to the vehicle. At least one user interface module is coupled to the mirror housing and includes a module viewing surface including at least one user input configured to be in communication with an external system to the vehicle. The at least one user input is configured to generate a signal to effectuate at least one of controlling a garage door, components of a smart home, or mobile device mirroring on a display of the module viewing surface.

These and other features, advantages, and objects of the present disclosure will be further understood and appreciated by those skilled in the art by reference to the following specification, claims, and appended drawings.

### BRIEF DESCRIPTION OF THE DRAWINGS

In the drawings:

FIG. 1 is an interior perspective view of a vehicle that includes a user interface module that is coupled to a rearview mirror assembly in accordance with an aspect of the present disclosure;

FIG. 2A is a front view of a user interface module that is coupled to a rearview mirror assembly of a first construction in accordance with an aspect of the present disclosure;

FIG. 2B is a side view of a user interface module that is coupled to a rearview mirror assembly of a first construction in accordance with an aspect of the present disclosure;

FIG. 3 is a cross-sectional view of a rearview mirror assembly with an electro-optic assembly in accordance with an aspect of the present disclosure;

FIG. 4A is a front view of a user interface module that is coupled to a rearview mirror assembly of a second construction in accordance with an aspect of the present disclosure;

FIG. 4B is a side view of a user interface module that is coupled to a rearview mirror assembly of a second construction in accordance with an aspect of the present disclosure;

FIG. 5A is a front view of a user interface module that is coupled to a rearview mirror assembly of a third construction in accordance with an aspect of the present disclosure;

FIG. 5B is a side view of a user interface module that is coupled to a rearview mirror assembly of a third construction in accordance with an aspect of the present disclosure;

FIG. 6A is a front view of a user interface module that is coupled to a rearview mirror assembly of a fourth construction in accordance with an aspect of the present disclosure;

FIG. 6B is a side view of a user interface module that is coupled to a rearview mirror assembly of a fourth construction in accordance with an aspect of the present disclosure;

FIG. 7A is a front view of a user interface module that is coupled to a rearview mirror assembly of a fifth construction in accordance with an aspect of the present disclosure;

FIG. 7B is a top view of a user interface module that is coupled to a rearview mirror assembly of a fifth construction in accordance with an aspect of the present disclosure; and

FIG. 8 is a schematic view of a global command system operated by an interface module in accordance with an aspect of the present disclosure.

### DETAILED DESCRIPTION

The present illustrated embodiments reside primarily in combinations of method steps and apparatus components related to a user interface module that is coupled to a rearview mirror assembly. Accordingly, the apparatus components and method steps have been represented, where appropriate, by conventional symbols in the drawings, showing only those specific details that are pertinent to understanding the embodiments of the present disclosure so as not to obscure the disclosure with details that will be readily apparent to those of ordinary skill in the art having the benefit of the description herein. Further, like numerals in the description and drawings represent like elements.

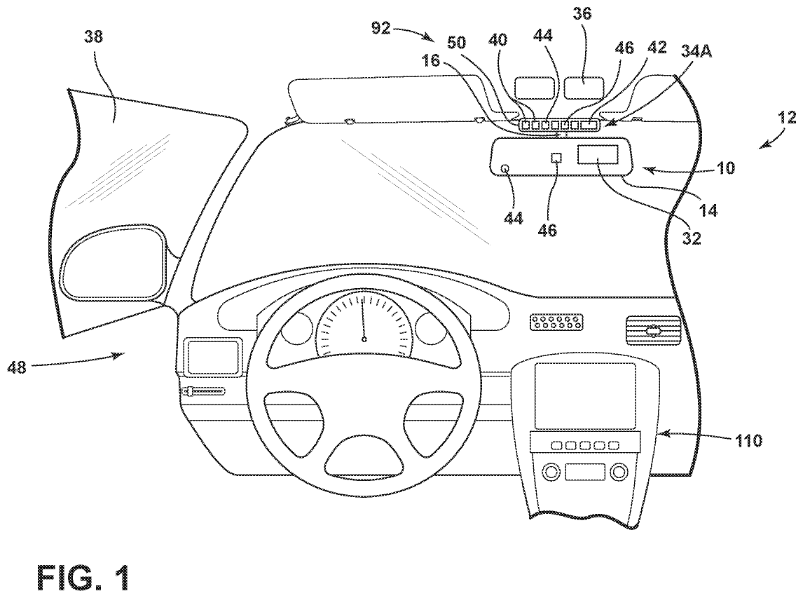

For purposes of description herein, the terms “upper,” “lower,” “right,” “left,” “rear,” “front,” “vertical,” “horizontal,” and derivatives thereof, shall relate to the disclosure as oriented in FIG. 1. Unless stated otherwise, the term “front” shall refer to the surface of the device closer to an intended viewer of the device, and the term “rear” shall refer to the surface of the device further from the intended viewer of the device. However, it is to be understood that the disclosure may assume various alternative orientations, except where expressly specified to the contrary. It is also to be understood that the specific devices and processes illustrated in the attached drawings, and described in the following specification, are simply exemplary embodiments of the inventive concepts defined in the appended claims. Hence, specific dimensions and other physical characteristics relating to the embodiments disclosed herein are not to be considered as limiting, unless the claims expressly state otherwise.

The terms “including,” “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element preceded by “comprises a . . . ” does not, without more constraints, preclude the existence of additional identical elements in the process, method, article, or apparatus that comprises the element.

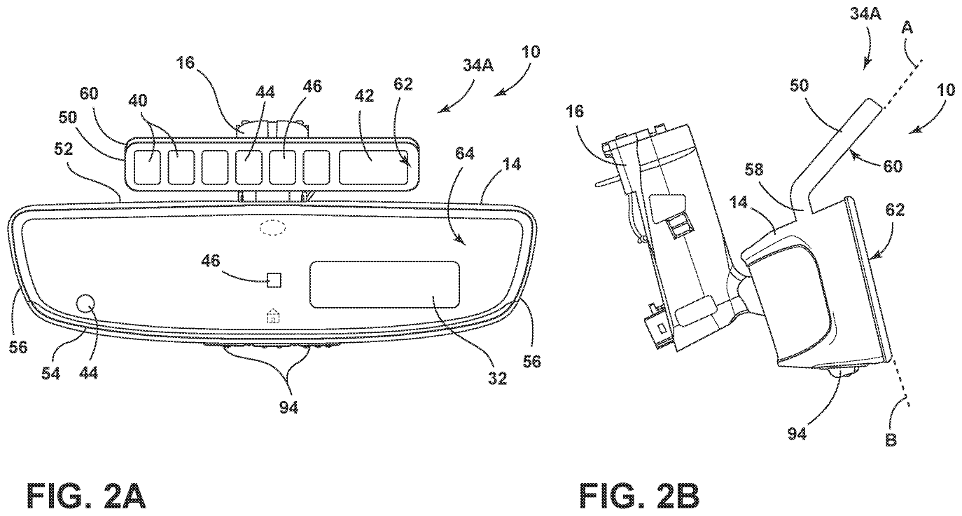

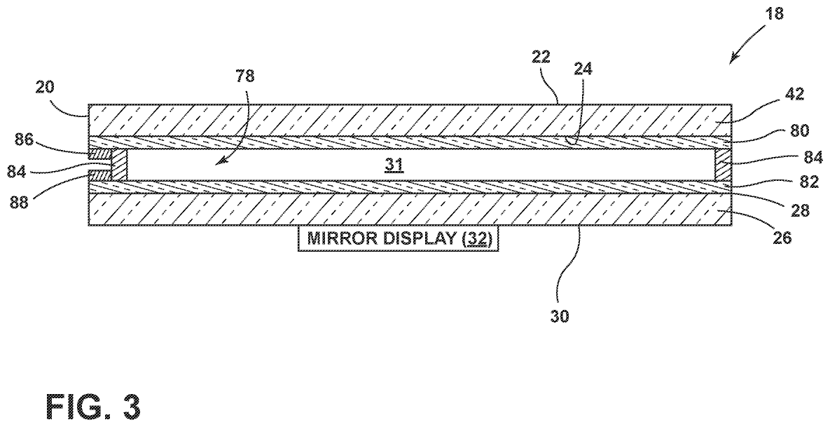

Referring now to FIGS. 1-2B, reference numeral 10 generally designates a mirror assembly for a vehicle 12 that includes a mirror housing 14 and a mounting member 16 configured to attach the mirror housing 14 to the vehicle 12. In some embodiments, an electro-optic assembly 18 (FIG. 3) is located in the mirror housing 14 (e.g., as a portion of an optical stack). The electro-optic assembly 18 includes a substantially transmissive front substrate 20. The front substrate 20 defines a first surface 22 and a second surface 24. The electro-optic assembly 18 further includes a rear substrate 26 that defines a third surface 28 and a fourth surface 30. An electro-optic medium 31 is disposed between the front substrate 20 and the rear substrate 26. A mirror display 32 is located in the mirror housing 14. A user interface module 34A of a first construction is connected to at least one of the mounting member 16 and an exterior 36 of the mirror housing 14. It should be appreciated that the mirror assembly 10 may be configured as a full display mirror assembly (e.g., with the electro-optic assembly 18 and the mirror display 32), a more traditional mirror assembly (e.g., without one or both of the electro-optic assembly 18 and the mirror display 32), a prismatic mirror, or the like.

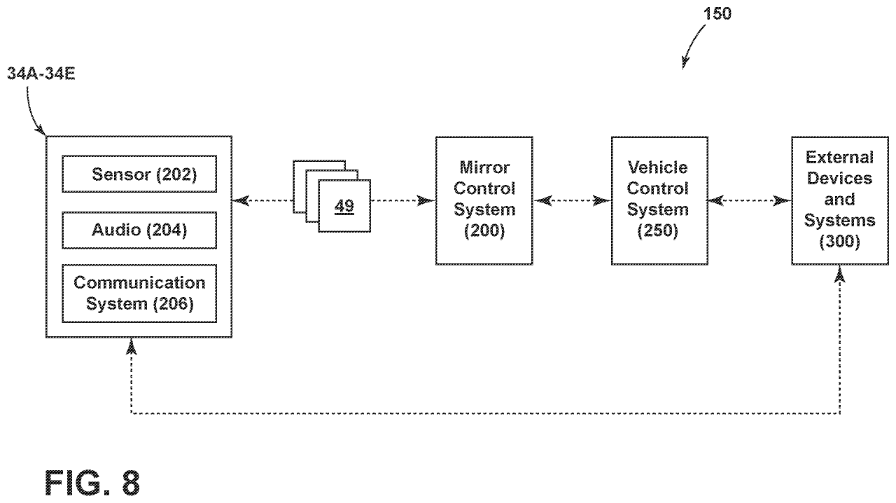

With continued reference to FIGS. 1-2B, the electro-optic assembly 18 and, more particularly, the electro-optic medium 31 may be electrochromic and electro-activated such that the mirror assembly 10 may be partially transmissive and have variable reflectance or transmissivity. In this manner, the mirror assembly 10 operates as a mirror, reflecting light at various wavelengths back towards an intended viewer. When the mirror display 32 is activated, the mirror assembly 10 relays information (e.g., a message or recommendation) to a vehicle operator. The user interface module 34A may control features of the mirror assembly 10 (e.g., display settings, electro-activating the electro-optic medium 31, telecommunications, and/or the like), may control features of the vehicle 12 (e.g., overhead lights 36, locking doors, opening and closing a window 38 such as a side window, a sunroof, and/or the like), or may control features of both the mirror assembly 10 and the vehicle 12. For example, the user interface module 34A may be configured to open and close the sunroof, articulate a roller blind of the sunroof, dim the sunroof, and/or opening and closing a garage door. In this manner, the sunroof may be electro-optic. As will be described in further detail in the description of FIG. 8, the user interface module 34A may also or alternatively control features of external devices and systems. In this manner, the user interface module 34A may be electrically coupled to both a mirror control system 200 and/or a vehicle control system 250 (FIG. 8). In some embodiments, the user interface module 34A may be electrically coupled to the vehicle control system 250 through the mirror control system 200.

With continued reference to FIGS. 1-2B, the user interface module 34A may include a plurality of inputs 40 (e.g., buttons, touch screen, toggles, and/or the like) and an output 42 (e.g., a display that generates messages, warning lights, and/or the like). In some embodiments, the user interface module 34A may be primarily a display that generates the inputs 40 in a reconfigurable manner (e.g., with touch buttons). The display (i.e., the output 42) may be configured as a singular or multi-color backlit LCD, Thin Film Transistor (“TFT”) LCD panel, organic light-emitting diode display (“OLED”), and/or the like. In some embodiments, the user interface module 34A may include additional features, such as a light source 44 and a camera 46. For example, the light source 44 may be configured to emit flood illumination within a visible spectrum (i.e., for viewing an interior cabin 48 of the vehicle 12) and/or illumination within a non-visible spectrum (e.g., infrared and/or near infrared illumination) such that the camera 46 can capture images 49 (FIG. 8) in low light environments. In some embodiments, the illumination source 44 may include other types of illumination, such as structured light patterns that can be captured by the camera 46 in the images 49 for extracting depth of the interior cabin 48 and vehicle occupants for monitoring purposes. The mirror assembly 10 may, likewise, include one or more of the light source 44 and the camera 46. For example, the mirror assembly 10 may include the camera 46 and the user interface module 34A may include the light source 44. Likewise, in some embodiments, the mirror assembly 10 may include the light source 44 and the user interface module 34A may include the camera 46. In this manner, the user interface module 34A may work in conjunction with the mirror assembly 10 to facilitate monitoring of the interior cabin 48.

With reference now to FIGS. 2A and 2B, the user interface module 34A of the first construction is connected to the mirror housing 14. For example, the user interface module 34A includes a module housing 50 that is integrally formed with the mirror housing 14 or otherwise connected thereto. As depicted, the user interface module 34A may be integrally formed with the mirror housing 14 and extend from a top surface 52 of the mirror housing 14. However, it should be appreciated that the user interface module 34A may extend from other portions of the mirror housing 14 or the mounting member 16. More particularly, the mirror housing 14 includes a bottom surface 54 opposite the top surface 52 and a pair of side surfaces 56 that space the top surface 52 from the bottom surface 54. In this manner, the user interface module 34A may be connected to and/or otherwise extend adjacent to the bottom surface 54 or the side surfaces 56 without departing from the scope of the subject disclosure. Each mounting location may be beneficial based on vehicular architecture. For example, the size (e.g., width and/or height) of a front window may dictate optimal positioning of the user interface module 34A.

When the user interface module 34A is connected to the mirror housing 14, articulation of the mirror housing 14 with respect to the mounting member 16 causes movement of the user interface module 34A. In this manner, when the user interface module 34A includes one of the camera 46 or the light source 44 and the mirror assembly 10 includes the other of the camera 46 or the light source 44, the spacing between the camera 46 and the light source 44 remains rigidly fixed. As such, various principles of monitoring (e.g., structured light, Time-of Flight, stereovision) the interior cabin 48 can be implemented (e.g., with components, such as the light source 44 and camera 46, in one or both of the mirror housing 14 and the module housing 50) without requiring additional resources from the mirror control system 200 (e.g., re-triangulation) to determine the spacing between the camera 46 and the light source 44. It should be appreciated that implementations of the mirror assembly 10 that operate under the principles of stereovision may include a pair of cameras 46, with one of the cameras 46 in the mirror assembly 10 (e.g., the mirror housing 14) and the other camera 46 in the user interface module 34A (e.g., in the module housing 50), both cameras 46 in the user interface module 34A (e.g., in the module housing 50), or both cameras in the mirror assembly 10 (e.g., the mirror housing 14). However, it should be appreciated that, in some embodiments, the user interface module 34A of the first construction may be connected to the mirror housing 14 and configured to articulate relative to the mirror housing 14.

With continued reference to FIGS. 2A and 2B, the user interface module 34A is depicted as extending from the top surface 52 of the mirror housing 14. The module housing 50 includes a connection portion 58 (FIG. 2B) that extends from the mirror housing 14 to an interface bezel 60 defining a module viewing surface 62 (i.e., the inputs 40 and outputs 42). The mirror housing 14 may, likewise, define a mirror bezel that positions internal components (i.e., the electro-optic assembly 18 and the mirror display 32) and defines a mirror viewing surface 64. The mirror viewing surface 64 may be defined by the electro-optic assembly 18 (i.e., the front substrate 20) or an additional substrate (not shown) separate from the electro-optic assembly 18 in the optical stack. The module viewing surface 62 may be oriented on a first plane A, and the mirror viewing surface 64 may be oriented on a second plane B that is different than the first plane A. For example, a line perpendicular to the first plane A and a line perpendicular to the second plane B may intersect generally at a location of a vehicle occupant (e.g., substantially in an average location of eyes). As such, the vehicle occupant can view both the first plane A and second plane B simultaneously without having to readjust in position. As depicted, the first plane A may be oriented at a downward angle with respect to the second plane B. However, it should be appreciated that when the user interface module 34A is located on other positions of the mirror housing 14 (i.e., the bottom surface 54), the first plane A may be at an upward angle or a downward angle with a less extreme pitch. Likewise, when the user interface module 34A is located on a side surface 56, the first plane A and second plane B may be oriented parallel or at a respective angle in the cross-car direction. Regardless of the relative location between the first and second planes A, B, the angle perpendicular to the planes A, B may intersect generally at a location of a vehicle occupant (e.g., substantially in an average location of eyes).

With reference now to FIG. 3, the electro-optic assembly 18 may only a portion of an optical stack within the mirror housing 14. The electro-optic assembly 18 (e.g., the electro-optic medium 31) may be a single-layer component, a single-phase component, a multi-layer component, and/or a multi-phase component that can be switched between variable reflectance states and/or variable transmissivity states. The electro-optic assembly 18 includes the front substrate 20 that has the first surface 22 and a second surface 24 opposite the first surface 22. The rear substrate 26 has the third surface 28 and the fourth surface 30 opposite the third surface 28. The second and third surfaces 24, 28 face each other to define a gap 78. A first electrode 80 is coupled to the second surface 24, and a second electrode 82 is coupled to the third surface 28. In some embodiments, the second electrode 82 may include a partially reflective, partially transmissive coating (e.g., a transreflective coating). The electro-optic medium 31 is located between the first electrode 80 and the second electrode 82. The electro-optic medium 31 may be retained within the gap 78 via a seal 84. A first electrical bus 86 may be connected to the first electrode 80, and a second electrical bus 88 may be connected to the second electrode 82. More particularly, the electrical buses 86, 88 may provide current to the electrodes 80, 82. The mirror display 32 is located on a rear side of the electro-optic assembly 18 (e.g., on a side of the electro-optic assembly 18 opposite of the viewer). In some embodiments, a reflective layer (e.g., a transreflective coating) may be located on the third or fourth surface 28, 30 in addition or alternatively the partially reflective, partially transmissive coating on the second electrode 82.

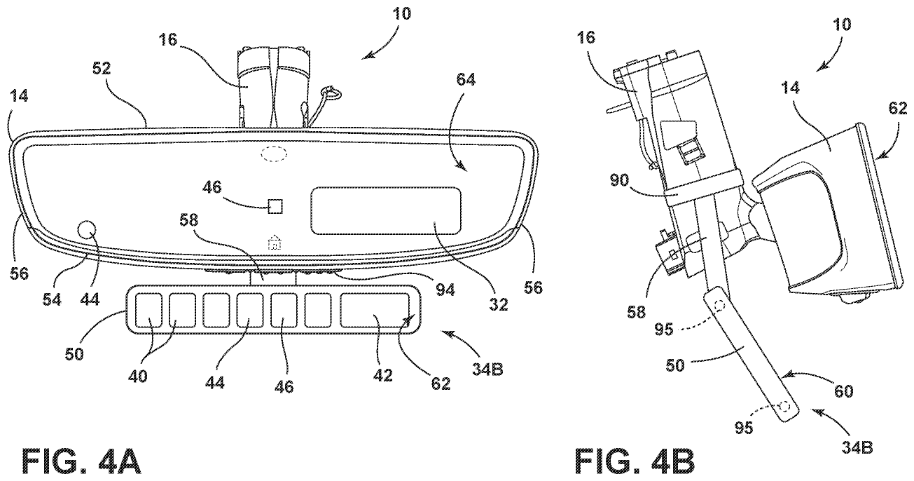

With reference now to FIGS. 4A and 4B, a user interface module 34B is depicted under a second construction. Unless otherwise indicated, the second construction may share all the same features, materials, and components, plane and angle orientations, and be connected to the same structures as the other constructions 34A, and 34C-34E. However, the user interface module 34B is connected to the mounting member 16 rather than the mirror housing 14. For example, the user interface module 34B includes a module housing 50 that is integrally formed with the mounting member 16 or, otherwise, connected thereto. As depicted, the user interface module 34B may be connected to the mounting member 16 via a bracket 90 and extend from the bottom surface 54 of the mirror housing 14. However, it should be appreciated that the user interface module 34B may extend from other portions of the mirror housing 14 and/or be respectively located with the mirror housing 14 as described in reference to the first construction.

With continued reference to FIGS. 4A and 4B, when the user interface module 34B is connected to the mounting member 16, the user interface module 34B remains statically fixed during articulation of the mirror housing 14. In this manner, when the user interface module 34B includes one of the camera 46 or the light source 44 and the mirror assembly 10 includes the other of the camera 46 or the light source 44, the spacing between the camera 46 and the light source 44 may change. As such, in some embodiments, the camera 46 and/or light source 44 outside of the user interface module 34B may be also rigidly fixed and not move during articulation of the mirror housing 14. For example, the camera 46 and/or light source 44 outside of the user interface module 34B may be rigidly fixed to the mounting member 16 or located in other areas of the interior cabin 48 (e.g., an overhead space 92). The mirror assembly 10 may include additional buttons 94 (e.g., toggles, reconfigurable touch inputs, and/or the like) that control features of the mirror assembly 10, the vehicle 12, and/or external devices and systems. As will be described in further detail in the description of FIG. 8, the user interface module 34B may also or alternatively control features of external devices and systems. In some embodiments, one or more positional sensors 95 may be located in both the mirror housing 14 and the module housing 50. In this manner, when the mirror housing 14 and/or the module housing 50 are independently moveable, the position sensors 95 can be used to determine relative positioning between the mirror housing 14 and the module housing 50.

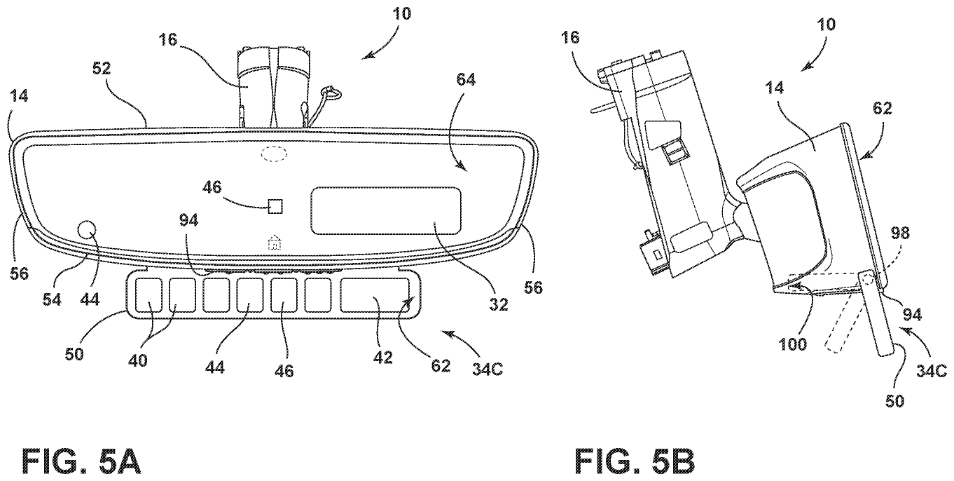

With reference now to FIGS. 5A and 5B, a user interface module 34C is depicted under a third construction. Unless otherwise indicated, the third construction may share all the same features, materials, and components, plane and angle orientations, and be connected to the same structures as the other constructions 34A, 34B, 34D, and 34E. However, the user interface module 34C is connected to the mirror housing 14 (e.g., the bottom surface 54) and articulatable (e.g., pivotal) between a stowed position and an active position (e.g., relative to the bottom surface 54). More particularly, the module housing 50 may be pivotally connected to the mirror housing 14 via a pivot linkage 98 (e.g., pivot pin and opening). The module housing 50 may be configured to be moved manually (e.g., by grabbing and articulating the module housing 50), automatically (e.g., via the control system 200 and/or additional buttons 94), semi-manually (e.g., with a push button and a spring member biasing the module housing 50 in the stowed or active position). In some embodiments, the mirror housing 14 may include an opening (e.g., a pocket 100) on the bottom surface 54 and the module housing 50 is in the pocket 100 in the stowed position. It should be appreciated that the user interface module 34C may be connected to and articulable relative to other portions of the mirror housing 14, such as the top surface 52.

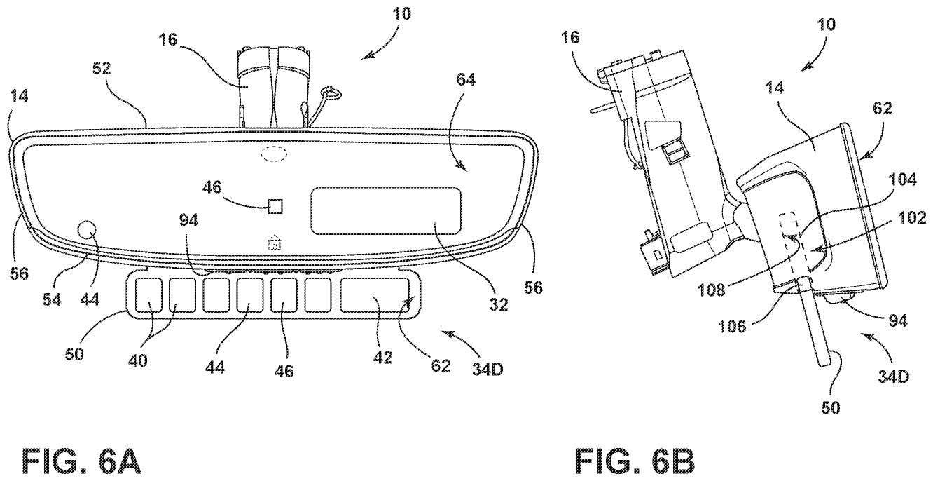

With reference now to FIGS. 6A and 6B, a user interface module 34D is depicted under a fourth construction. Unless otherwise indicated, the fourth construction may share all the same features, materials, and components, plane and angle orientations, and be connected to the same structures as the other constructions 34A-34C, and 34E. However, the user interface module 34D is connected to the mirror housing 14 (e.g., the bottom surface 54) and articulatable (e.g., slidable) between a stowed position and an active position (e.g., relative to the bottom surface 54). More particularly, the module housing 50 may be slidably connected to the mirror housing 14 via a track mechanism 102 (e.g., a track 104 and a carrier 106). The module housing 50 may be configured to be moved manually (e.g., by grabbing and articulating the module housing 50), automatically (e.g., via the control system 200 and/or additional buttons 94), semi-manually (e.g., with a push button and a spring member biasing the module housing 50 in the stowed or active position). In some embodiments, the mirror housing 14 may include an opening (e.g., an aperture 108 in the bottom surface 54) and the module housing 50 is in the aperture 108 in the stowed position. In some embodiments, the track 104 and the carrier 106 are configured in a rack and pinion arrangement and driven by an electric motor (e.g., automatically) between the stowed and active position. It should be appreciated that the user interface module 34D may be connected to and articulable relative to other portions of the mirror housing 14, such as the top surface 52.

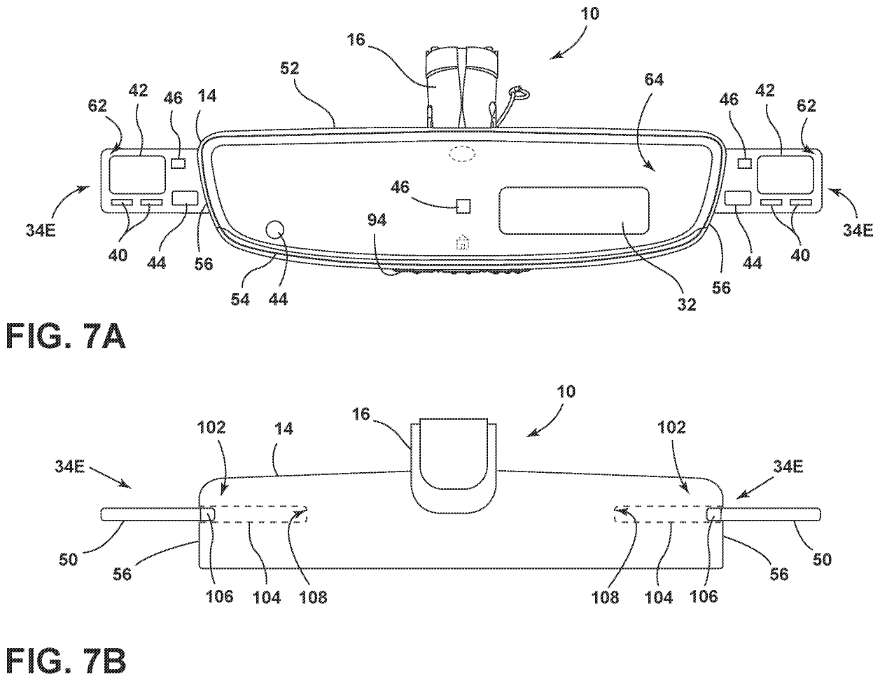

With reference now to FIGS. 7A and 7B, a user interface module 34E is depicted under a fifth construction. Unless otherwise indicated, the fifth construction may share all the same features, materials, and components, plane and angle orientations, and be connected to the same structures as the other constructions 34A-34D. However, the user interface module 34E is connected to the mirror housing 14 (e.g., one or both of the side surfaces 56) and articulatable (e.g., slidable) between a stowed position and an active position (e.g., relative to the side surface 56). In some embodiments, the user interface module 34E of the fifth construction may include a pair of module housing 50 each with the module viewing surface 62. While the other constructions described herein may have the following respective locations and configurations, it should be appreciated, in the fifth construction, the viewing surfaces 62 may also include reflective qualities (e.g., from an electro-optic assembly and/or a reflective layer). In such embodiments, the first plane A may be oriented towards one or more blind spots around the vehicle. In this manner, the user interface module 34E (e.g., the one or more viewing surfaces 62) may supplement the mirror viewing surface 64 to provide a driver real time vision of the surrounding area (e.g., blind spots) rather than or in addition to relying on the output 42 (e.g., display). However, it should be appreciated that the output 42 (e.g., display) in each construction may be configured to show images from blind spots (e.g., via one or more external cameras). In some embodiments, the pair of module housing 50 and respective ones of the module viewing surfaces 62 may each be oriented towards different blind spots. In some embodiments, the pair of module housings 50 may articulate to change the first plane A relative to the mirror housing 14. Similar to the fourth construction, the module housing 50 (e.g., pair of module housings 50) of the user interface module 34E may be slidably connected to the mirror housing 14 via a track mechanism 102 (e.g., a track 104 and a carrier 106). The module housing 50 (e.g., pair of module housings 50) may be configured to be moved manually (e.g., by grabbing and articulating the module housings 50), automatically (e.g., via the control system 200 and/or additional buttons 94), semi-manually (e.g., with a push button and a spring member biasing the module housings 50 in the stowed or active position). Each of the module housings 50 may be independently articulatable between the articulated and stowed positions and/or to change the first plane A. In some embodiments, the mirror housing 14 may include an opening (e.g., the aperture 108 but in the side surfaces 56) and the module housing 50 is in the aperture 108 in the stowed position. In some embodiments, the track 104 and the carrier 106 are configured in a rack and pinion arrangement and driven by an electric motor (e.g., automatically) between the stowed and active position. It should be appreciated that the user interface module 34D may be connected to and articulable relative to other portions of the mirror housing 14, such as the top surface 52. It should be appreciated that the user interface module 34E (e.g., the pair of module housings 50) may be connected to and articulable relative to other portions of the mirror housing 14, such as the top surface 52 and/or bottom surface 54. It should be appreciated that, in some embodiments, the interface module 34E may only include one module housing 50 on the left or right side surfaces 56.

With reference now to FIGS. 1-7B, various examples have been provided for controlling features of the mirror assembly 10, the vehicle 12, and/or externals devices and systems with the user interface module 34A-34E. However, it should be appreciated that these features are non-exhaustive. For example, the user interface module 34A-34E may control additional features of the mirror assembly 10, the vehicle 12, and/or external devices and systems. In some embodiments, the output 42 (e.g., display) on the user interface module 34A-34E may receive signals from either the mirror assembly 10, the vehicle 12, and/or external devices and systems to generate a status indicator, such as an airbag setting, light setting status (e.g., interior lighting and/or notification lights), blind spot detection, seatbelt status, and/or the like. In some embodiments, the features of the mirror assembly 10, the vehicle 12, and/or external devices and systems that are controlled by the user interface module 34A-34E may also be controlled by the mirror assembly 10 and/or a vehicle user interface 110 (FIG. 1). In other embodiments, the features of the mirror assembly 10, the vehicle 12, and/or external devices and systems that are controlled by the user interface module 34A-34E may only be controlled by the user interface module 34A-34E. It should also be appreciated that, in some embodiments, the mirror assembly 10 may be described as a rearview mirror 10 that does not include all the features described in reference to the mirror assembly 10 (e.g., the electro-optic assembly 18, the mirror display 32, the light source 44, and/or the camera 46). As such, the rearview mirror 10 may be a conventional-type rearview mirror and the user interface module 34A-34E may control features of the vehicle 12 only and/or may incorporate the features of the mirror assembly 10 (e.g., the light source 44 and the camera 46) for monitoring the interior cabin 48 independently from the mirror assembly 10. In this manner, the user interface module 34A-34E may effectively be added to the rearview mirror 10 (i.e., a conventional rearview mirror) to facilitate monitoring functionality independently. In some embodiments, the user interface module 34A-34E (e.g., the module housing 50 and/or inputs 40) may be spaced a non-nominal distance from the mirror housing 14. The distance permits a vehicle occupant to grab and interact with the mirror housing 14 independently from the user interface module 34A-34E. The user interface module 34A-34E facilitates the control of additional features of the mirror assembly 10, the vehicle 12, and/or external devices and systems without requiring additional spacing requirements within the mirror housing 14 and/or other locations of the interior cabin 48. In some embodiments, the output 42 (e.g., display) in each construction may be configured to switch between only partially covering the module viewing surface 62 and fully covering the module viewing surface 62 (e.g., by user preference, selection, and/or automatically under certain conditions). For example, when receiving images from an external camera, the display may automatically cover substantially the entire module viewing surface 62 (e.g., from only partially covering the module viewing surface 62). Further, where applicable, the first plane A may be adjustable relative to the second plane B, for aligning with a vehicle operator's preferences.

With reference now to FIG. 8, a global control system 150 is illustrated that includes the mirror control system 200 and the vehicle control system 250. As explained previously, the user interface module 34A-34E may be electrically coupled directly to the vehicle control system 250 or through the mirror control system 200. The user interface module 34A-34E may include one or more sensors 202, for example, light sensors, air sensors, the positional sensors 95, and audio sensors, that transmit readings to the mirror control system 200 and/or the vehicle control system 250. The user interface module 34A-34E may further include an audio module 204 (e.g., a speaker and a microphone) to facilitate telecommunications and/or verbal feature selection. The mirror assembly 10 in conjunction with the user interface module 34A-34E may, therefore, function as a gateway to the features of the mirror assembly 10 (e.g., driver monitoring, generating graphics, etc.) or the vehicle 12 (e.g., opening windows, overhead lights, emergency call buttons, airbag on and/off control, etc.). Further, the user interface module 34A-34E may include a uni or bidirectional wired or radio frequency communication system 206, for example, LIN, CAN, Flexray, ISM Sub-GHz bands, HomeLink, Bluetooth, WiFi, NFC, cloud networking, the like, and/or combinations thereof. The communication system 206 is configured to communicate either with the vehicle networking (e.g., vehicle control system 250), different vehicle devices (including the mirror assembly 10), or external devices and systems 300, such as navigational tools, telecommunications, garage doors, mobile device mirroring, connecting with smart home controls and components thereof (e.g., lighting, heating, cameras, security systems), and/or the like.

The disclosure herein is further summarized in the following paragraphs and is further characterized by combinations of any and all of the various aspects described therein.

According to one aspect of the present disclosure, a mirror assembly for a vehicle that includes a mirror housing and a mounting member is configured to attach the mirror housing to the vehicle. An optical stack includes an electro-optic assembly that is located in the mirror housing. The electro-optic assembly includes a substantially transmissive front substrate. The front substrate defines a first surface and a second surface. The electro-optic assembly further includes a rear substrate that defines a third surface and a fourth surface. An electro-optic medium is disposed between the front substrate and the rear substrate. A mirror display is located in the mirror housing. A user interface module is connected to at least one of the mounting member and an exterior of the mirror housing.

According to another aspect, a mirror control system is located in a mirror housing and a user interface module is configured to be electrically coupled to the mirror control system and transmit a signal to the mirror control system to effectuate at least one of changing the state of the electro-optic assembly or generating a graphic on the mirror display.

According to yet another aspect, a user interface module is configured to be in communication with a vehicle control system and transmit a signal to the vehicle control system to effectuate at least one of turning on lights in an interior cabin of the vehicle, sending and receiving communications, opening and closing a sunroof, articulating a roller blind of the sunroof, dimming the sunroof, and opening and closing a garage door.

According to still another aspect, a user interface module includes a module viewing surface with a plurality of inputs.

According to another aspect, a user interface module includes a module display configured to generate a warning.

According to yet another aspect, a generated warning includes at least one of an airbag notification or an interior light status.

According to still another aspect, a user interface module includes a connection bracket that is configured to be selectively connected to at least one of the mounting member and an exterior of the mirror housing.

According to another aspect, a user interface module includes a module housing that is integral with the mirror housing.

According to yet another aspect, a user interface module extends from a lower surface of a mirror housing.

According to still another aspect, a user interface module extends from an upper surface of a mirror housing.

According to another aspect, a user interface module includes a module viewing surface oriented substantially along a first plane and a mirror viewing surface is oriented substantially along a second plane, wherein a line perpendicular to the first plane and a line perpendicular to the second plane intersect at a location of a vehicle occupant.

According to another aspect of the present disclosure, a mirror assembly for a vehicle includes a mirror housing defining at least one opening. A mirror viewing surface is coupled to the mirror housing and a mounting member is configured to attach the mirror housing to the vehicle. At least one user interface module is coupled to the mirror housing and moveable between a stowed position within the at least one opening and an active position at least partially outside of the at least one opening. The at least one user interface module includes at least one user input configured to be in communication with at least one of a mirror control system or a vehicle control system. The at least one user interface module further includes a module viewing surface configured to visualize a blind spot by at least one of generating images of the blind spot on a display or reflecting the blind spot from a reflective surface.

According to another aspect, a module viewing surface is configured to visualize a blind spot by reflecting the blind spot from a reflective surface.

According to yet another aspect, a mirror housing includes a pair of opposing sides surfaces and at least one opening includes a pair of openings each located in a different one of the opposing side surfaces, and wherein at least one user interface module includes a pair of user interface modules located and moveable within a different one of the pair of openings.

According to still another aspect, each of a pair of user interface modules are configured to visualize blind spots on opposite sides of a vehicle by reflecting the blind spots from a reflective surface.

According to another aspect, at least one user input is configured to be in communication with a vehicle control system and to transmit a signal to the vehicle control system to effectuate at least one of turning on lights in an interior cabin of the vehicle, sending and receiving communications, opening and closing a sunroof, articulating a roller blind of the sunroof, dimming the sunroof, and opening and closing a garage door.

According to yet another aspect, at least one opening is located in a bottom surface of a mirror housing and at least one user interface module is pivotally connected proximate the at least one opening between the stowed position the active position.

According to still another aspect, at least one opening is located in a bottom surface of a mirror housing and at least one user interface module is slidably connected within the at least one opening between the stowed position the active position.

According to yet another aspect of the present disclosure, a mirror assembly for a vehicle includes a mirror housing and a mirror viewing surface coupled to the mirror housing. A mounting member is configured to attach the mirror housing to the vehicle. At least one user interface module is coupled to the mirror housing and includes a module viewing surface including at least one user input configured to be in communication with an external system to the vehicle. The at least one user input is configured to generate a signal to effectuate at least one of controlling a garage door, a components of a smart home, or mobile device mirroring on a display of the module viewing surface.

According to another aspect, a module viewing surface is located on a first plane and a mirror viewing surface is located on a second plane, and the first plane is adjustable relative to the second plane.

It will be understood by one having ordinary skill in the art that construction of the described disclosure and other components is not limited to any specific material. Other exemplary embodiments of the disclosure disclosed herein may be formed from a wide variety of materials, unless described otherwise herein.

For purposes of this disclosure, the term “coupled” (in all of its forms, couple, coupling, coupled, etc.) generally means the joining of two components (electrical or mechanical) directly or indirectly to one another. Such joining may be stationary in nature or movable in nature. Such joining may be achieved with the two components (electrical or mechanical) and any additional intermediate members being integrally formed as a single unitary body with one another or with the two components. Such joining may be permanent in nature or may be removable or releasable in nature unless otherwise stated.

As used herein, the term “about” means that amounts, sizes, formulations, parameters, and other quantities and characteristics are not and need not be exact, but may be approximate and/or larger or smaller, as desired, reflecting tolerances, conversion factors, rounding off, measurement error and the like, and other factors known to those of skill in the art. When the term “about” is used in describing a value or an end-point of a range, the disclosure should be understood to include the specific value or end-point referred to. Whether or not a numerical value or end-point of a range in the specification recites “about,” the numerical value or end-point of a range is intended to include two embodiments: one modified by “about,” and one not modified by “about.” It will be further understood that the end-points of each of the ranges are significant both in relation to the other end-point, and independently of the other end-point.

The terms “substantial,” “substantially,” and variations thereof as used herein are intended to note that a described feature is equal or approximately equal to a value or description. For example, a “substantially planar” surface is intended to denote a surface that is planar or approximately planar. Moreover, “substantially” is intended to denote that two values are equal or approximately equal. In some embodiments, “substantially” may denote values within about 10% of each other, such as within about 5% of each other, or within about 2% of each other.

It is also important to note that the construction and arrangement of the elements of the disclosure, as shown in the exemplary embodiments, is illustrative only. Although only a few embodiments of the present innovations have been described in detail in this disclosure, those skilled in the art who review this disclosure will readily appreciate that many modifications are possible (e.g., variations in sizes, dimensions, structures, shapes and proportions of the various elements, values of parameters, mounting arrangements, use of materials, colors, orientations, etc.) without materially departing from the novel teachings and advantages of the subject matter recited. For example, elements shown as integrally formed may be constructed of multiple parts, or elements shown as multiple parts may be integrally formed, the operation of the interfaces may be reversed or otherwise varied, the length or width of the structures and/or members or connectors or other elements of the system may be varied, and the nature or number of adjustment positions provided between the elements may be varied. It should be noted that the elements and/or assemblies of the system may be constructed from any of a wide variety of materials that provide sufficient strength or durability, in any of a wide variety of colors, textures, and combinations. Accordingly, all such modifications are intended to be included within the scope of the present innovations. Other substitutions, modifications, changes, and omissions may be made in the design, operating conditions, and arrangement of the desired and other exemplary embodiments without departing from the spirit of the present innovations.

It will be understood that any described processes or steps within described processes may be combined with other disclosed processes or steps to form structures within the scope of the present disclosure. The exemplary structures and processes disclosed herein are for illustrative purposes and are not to be construed as limiting.

It is also to be understood that variations and modifications can be made on the aforementioned structures and methods without departing from the concepts of the present disclosure, and further it is to be understood that such concepts are intended to be covered by the following claims unless these claims by their language expressly state otherwise.

What is claimed is:

1. A mirror assembly for a vehicle, the mirror assembly comprising:
a mirror housing;
a mounting member configured to attach the mirror housing to the vehicle;
an optical stack in the mirror housing including a mirror viewing surface and an electro-optic assembly, the electro-optic assembly including:
a substantially transmissive front substrate, the front substrate defining a first surface and a second surface;
a rear substrate defining a third surface and a fourth surface; and
an electro-optic medium disposed between the front substrate and the rear substrate;
a mirror display located in the mirror housing; and
a user interface module connected to at least one of the mounting member and an exterior of the mirror housing.

2. The mirror assembly of claim 1, including a mirror control system located in the mirror housing and the user interface module is configured to be electrically coupled to the mirror control system and transmit a signal to the mirror control system to effectuate at least one of changing a state of the electro-optic assembly or generating a graphic on the mirror display.

3. The mirror assembly of claim 1, wherein the user interface module is configured to be in communication with a vehicle control system and transmit a signal to the vehicle control system to effectuate at least one of turning on lights in an interior cabin of the vehicle, sending and receiving communications, opening and closing a sunroof, articulating a roller blind of the sunroof, dimming the sunroof, and opening and closing a garage door.

4. The mirror assembly of claim 1, wherein the user interface module includes a module viewing surface with a plurality of inputs.

5. The mirror assembly of claim 4, wherein the user interface module includes a module display configured to generate a warning.

6. The mirror assembly of claim 5, wherein the generated warning includes at least one of an airbag notification or an interior light status.

7. The mirror assembly of claim 5, wherein the user interface module includes a connection bracket that is configured to be selectively connected to at least one of the mounting member and the exterior of the mirror housing.

8. The mirror assembly of claim 5, wherein the user interface module includes a module housing that is integral with the mirror housing.

9. The mirror assembly of claim 5, wherein the user interface module extends from a lower surface of the mirror housing.

10. The mirror assembly of claim 5, wherein the user interface module extends from an upper surface of the mirror housing.

11. The mirror assembly of claim 1, wherein the user interface module includes a module viewing surface oriented substantially along a first plane and the mirror viewing surface is oriented substantially along a second plane, wherein a line perpendicular to the first plane and a line perpendicular to the second plane intersect at a location of a vehicle occupant.

12. A mirror assembly for a vehicle, the mirror assembly comprising:
a mirror housing defining at least one opening;
a mirror viewing surface coupled to the mirror housing;
a mounting member configured to attach the mirror housing to the vehicle; and
at least one user interface module coupled to the mirror housing and moveable between a stowed position within the at least one opening and an active position at least partially outside of the at least one opening, the at least one user interface module comprising:
at least one user input configured to be in communication with at least one of a mirror control system or a vehicle control system; and
a module viewing surface configured to visualize a blind spot by at least one of generating images of the blind spot on a display or reflecting the blind spot from a reflective surface.

13. The mirror assembly of claim 12, wherein the module viewing surface is configured to visualize the blind spot by reflecting the blind spot from the reflective surface.

14. The mirror assembly of claim 12, wherein the mirror housing includes a pair of opposing sides surfaces and the at least one opening includes a pair of openings each located in a different one of the opposing side surfaces, and wherein the at least one user interface module includes a pair of user interface modules located and moveable within a different one of the pair of openings.

15. The mirror assembly of claim 14, wherein each user interface module are configured to visualize blind spots on opposite sides of the vehicle by reflecting the blind spots from the reflective surface.

16. The mirror assembly of claim 12, wherein the at least one user input is configured to be in communication with the vehicle control system and transmit a signal to the vehicle control system to effectuate at least one of turning on lights in an interior cabin of the vehicle, sending and receiving communications, opening and closing a sunroof, articulating a roller blind of the sunroof, dimming the sunroof, and opening and closing a garage door.

17. The mirror assembly of claim 12, wherein the at least one opening is located in a bottom surface of the mirror housing and the at least one user interface module is pivotally connected proximate the at least one opening between the stowed position the active position.

18. The mirror assembly of claim 12, wherein the at least one opening is located in a bottom surface of the mirror housing and the at least one user interface module is slidably connected within the at least one opening between the stowed position the active position.

19. A mirror assembly for a vehicle, the mirror assembly comprising:
a mirror housing;
a mirror viewing surface coupled to the mirror housing;
a mounting member configured to attach the mirror housing to the vehicle; and
a user interface module coupled to the mirror housing, the user interface module comprising:
a module viewing surface including at least one user input configured to be in communication with an external system to the vehicle; and
the at least one user input configured to generate a signal to effectuate at least one of controlling a garage door, a components of a smart home, or mobile device mirroring on a display of the module viewing surface.

20. The mirror assembly of claim 19, wherein the module viewing surface is located on a first plane and the mirror viewing surface is located on a second plane, and the first plane is adjustable relative to the second plane.
